(19) United States
(12) Patent Application Publication
(10) Pub. No.: US 2014/0197163 A1
(43) Pub. Date: Jul. 17, 2014

(54) MICROWAVE MODE STIRRER APPARATUS

(71) Applicant: Standex International Corporation, Salem, NH (US)

(72) Inventor: Neal Cooper, North Richland Hills, TX (US)

(73) Assignee: Standex International Corporation, Salem, NH (US)

(21) Appl. No.: 14/164,405

(22) Filed: Jan. 27, 2014

Related U.S. Application Data
(60) Provisional application No. 61/753,021, filed on Jan. 16, 2013.

(51) Int. Cl. H05B 6/74

(52) U.S. Cl. CPC H05B 6/745
USPC 219/751

(57) ABSTRACT

A mode stirrer apparatus that enables a more effective heating pattern in the food that is to be cooked. Two mode stirrers located in opposite walls of the oven. Each mode stirrer is independently driven by a small gear motor that causes the mode stirrer to rotate in only one direction. The result of this mounting configuration is that the mode stirrers rotate in a counter-rotating fashion in relation to the food being cooked. The mode stirrer in this invention has a combination of radiating slots (which behave like a rod shaped dipole antenna) and large areas of angled/displaced metal.

This application claims benefit of U.S. Provisional Application Ser. No. 61/753021, filed Jan. 16, 2013, pursuant to 35 USC §119(e),

### FIELD OF THE INVENTION

This invention relates to a mode stirrer, in particular, a mode stirrer for use in microwave ovens.

### BACKGROUND OF THE INVENTION

Microwave ovens are an effective means of delivering heat to food products, imparting heat directly to the product via radiated waves. These waves are generated by a magnetron, fed down a waveguide, and then delivered directly into the oven cavity by a waveguide opening.

The most common problem of microwave ovens is uneven heating of products. Due to the nature of microwaves themselves interacting with food products, hot and cold spots occur. The non-uniform distribution of waves, along with the changes in the food product properties as it heats make hot and cold spots a certainty.

In the prior art, turntables have been one of the most common methods for improving uniformity of microwave heating. Other methods are the use of directional antennas to direct the desired pattern for producing uniform heating. These antenna arrays are usually more successful for certain types of foods, but not for others, with the result being inconsistent cooking/heating results.

Mode stirrers are another attempt to create random microwave fields within the heating cavity. These provide some improvement, but are usually only marginally effective. Mode stirrers change the standing wave pattern inside a microwave cavity by any or all of the following methods . . . changing the point of introduction of microwave energy into the cavity, changing the effective shape/size of the cavity and/or changing the oscillation frequency of the magnetron (load pulling). The changing oven cavity modes will result in a changing electro-magnetic field around the food item being cooked. A simple rod shaped antenna, by rotating inside the oven cavity, changes the point of introduction of microwave energy. This rotation results in excitation of different modes inside the cavity. Mode stirrers with large holes or with the presence or absence of a large area of metal will effectively change the geometry of the oven as the mode stirrer rotates.

There is not found in the prior art a mode stirring apparatus that improves the effectiveness by utilizing two mode stirrers in opposite walls of the oven wherein the stirrers rotate in a counter-rotating manner and wherein the stirrer has a unique curved shape, which permits a smaller sized stirrer.

### SUMMARY OF THE INVENTION

It is an aspect of the invention to provided an improve microwave mode stirring apparatus that enables a more effective heating pattern in the food that is to be cooked in the oven. In order to improve the effectiveness of a single mode stirrer, this oven utilizes two mode stirrers located in opposite walls of the oven. Each mode stirrer is independently driven by a small gear motor that causes the mode stirrer to rotate in only one direction. The result of this mounting configuration is that the mode stirrers rotate in a counter-rotating fashion in relation to the food being cooked. The mode stirrer in this invention has a combination of radiating slots (which behave like a rod shaped dipole antenna) and large areas of angled/displaced metal.

### BRIEF DESCRIPTION OF THE DRAWINGS

FIG. 1 is an isometric view of a typical microwave oven with the side panel and waveguide cover removed showing the mode stirrer in place in accordance with the invention.

FIG. 2 is an isometric cross-sectional detailed view of one of the pair slotted mode stirrers in accordance with the invention.

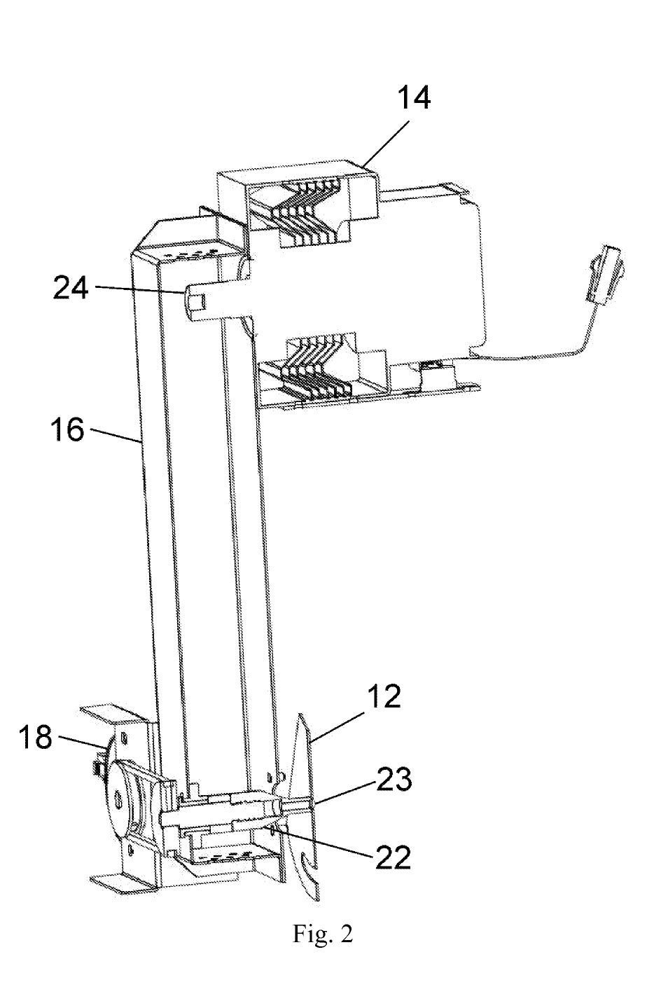

FIG. 3 is a detailed view of the invention.

### DETAILED DESCRIPTION OF THE INVENTION

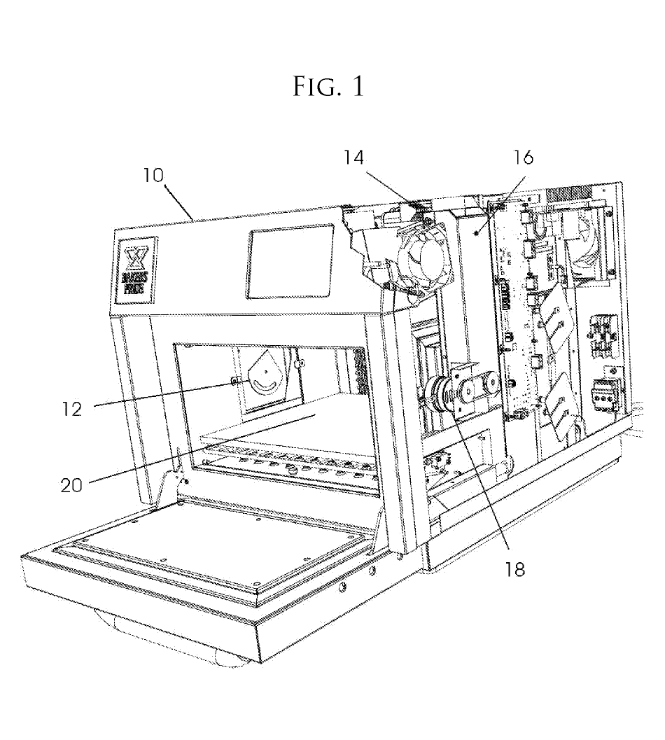

Referring to FIG. 1, microwave energy in a microwave oven is generated by the magnetron 14. The microwave energy (in the form of an electro-magnetic wave, EM) is emitted from the magnetron antenna 24 and travels down the waveguide 16. Near the other end of the waveguide, the EM wave couples to a rotating metallic antenna 22. Mode stirrer 12 is affixed to the end of antenna 22 by a screw 23. Microwave energy radiates from the slots in the mode stirrer 12.

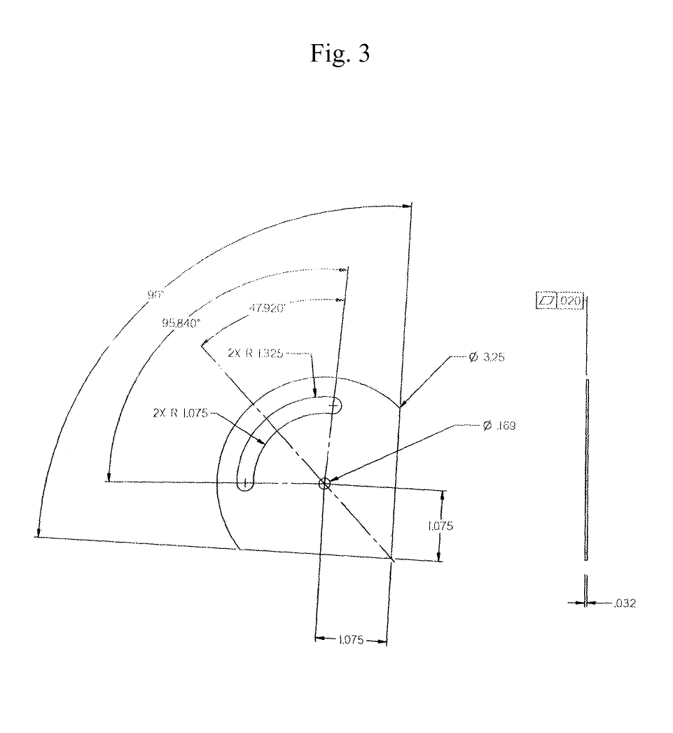

Referring now to FIG. 3, the preferred configuration of mode stirrer 12 with the preferred dimension for a typical microwave oven is shown. The use of the curved shape for the slot allows a more compact stirrer than if the slot was straight. The center of rotation is approximately 1 inch in from each side as shown. The two straight edges are 90 degrees from one another. The radius of the curved edge is approximately 3¼ inches in length. The slot is approximately ¼ inch wide.

Residential microwave ovens generally have only one magnetron but most commercial ovens have two or more. The purpose in having two magnetrons is to have more microwave power. A single magnetron having greater power could be used, but the cost of a single magnetron of sufficient power is greater than the cost of having two lesser power magnetrons. Also, the use of two mode stirrers eliminates the problem of excessive heating on one side of the cooking cavity without the need for a rotating turntable that is found typically in most residential ovens.

The mode pattern in the oven cavity, as well as the energy distribution in the cavity changes as the mode stirrer 12 rotates. Having two mode stirrers on opposite walls of the oven, rotating in opposite directions minimizes the amount of cross talk between the two magnetrons 14. This is due to the fact that the two mode stirrers 12 will seldom be in phase with each other.

Although the present invention has been described with reference to certain preferred embodiments thereof, other versions are readily apparent to those of ordinary skill in the preferred embodiments contained herein.

What is claimed is:

1. A mode stirrer apparatus for a microwave oven with a heating cavity, wherein the heating cavity having at least two opposing side walls and the microwave oven having at least two magnetrons providing microwave energy to the heating cavity, said apparatus comprising:
a wave guide for each of said at least two magnetrons directing the microwave energy from said at least two magnetrons;
a rotating metallic antenna in communication with its corresponding wave guide with each rotating metallic antenna attached within one of said opposing side walls and rotating perpendicular to the side wall and in direction opposite to said rotating metallic antenna on the opposing side wall;
a metallic mode stirrer at one end of each rotating metallic antenna, wherein each said metallic mode stirrer minimizes the cross talk between the at least two magnetrons and wherein microwave energy in the heating cavity is evenly distributed as each said mode stirrer rotates.

2. The mode stirrer apparatus of claim 1 wherein each said metallic mode stirrer being a thin plate and having a shape with two straight side edges perpendicular to one another with a third edge being arcuate shaped and with a center of rotation being substantially equidistant from each straight perpendicular edge.

3. The mode stirrer apparatus of claim 2 wherein said arcuate third edge has a radius of approximately 3 inches.

4. The mode stirrer apparatus of claim 2 wherein each said metallic mode stirrer further comprises a arcuate shaped slot wherein microwave energy radiates from said arcuate slot.
